(19) United States
(12) Patent Application Publication
(10) Pub. No.: US 2008/0105068 A1
(43) Pub. Date: May 8, 2008

(54) PROBE FOR WATER COOLERS

(76) Inventor: George Michael Yui, Toronto (CA)

Correspondence Address: MICHAEL RIES, 318 PARKER PLACE, OSWEGO, IL, 60543, US

(21) Appl. No.: 11/934,664

(22) Filed: Nov. 2, 2007

(30) Foreign Application Priority Data
Nov. 2, 2006 (CN) 200620139616.8

(51) Int. Cl. G01D 21/00

(52) U.S. Cl. 73/866.5

(57) ABSTRACT

The present invention is a probe for a water cooler including a hollow polygonal bottom seat and columniform thread seat and probe column installed on the bottom seat. The probe column having openings forming a set of long slots, which can go through an inside of a pipe on a side of the probe column. A probe column top diameter is a little smaller then a probe column diameter and there are at least one set of protruding ridges on the top of the probe column the distance between a probe column top end. The at least one protruding ridge is smaller then the height of a water bottle seal cap.

This application claims the benefit of Chinese Patent Application No. 200620139616.8 filed Nov. 2, 2006.

### TECHNICAL FIELD & BACKGROUND

The present invention generally relates to the field of probes for water coolers.

A water cooler, as a kind of daily widely used electrical appliance, is more and more popular. A probe is an important part in the water cooler, so it needs to be improved constantly. Other probes in the market now set up a whole circle of ring slots on the top of a probe column, and open up a round hole as an inlet hole on one side, this kind of design is a limitation when the probe enters the water bottle seal cap because the contact area is big, the friction resistance is also big, it is difficult to enter, most of the time, the seal cap cannot be inserted by the probe, but floats in the water bottle, it does not look clean; another limitation is that water must enter the inside of pipe by probe side round hole, then enter the water cooler through a long inside pipe, this way the water down resistance is very big, speed is very slow, also it can produce a big sound, to affect people's work and thoughts in an office setting.

The technology problem solved by the present invention as to the above existing problems is to provide a kind of probe for a water cooler with a simple structure, easily inserted through water bottle seal cap, improved water flow, and fast down speed with low noise.

The technology design adopted by the present probe for water coolers has a hollow polygon bottom seat, and columniform threaded seat and probe column installed on the hollow polygon bottom seat. On the side of the stated probe column, opening up a set of long slot which is through the inside, the top diameter of the probe column is a little smaller then probe column's diameter, and setting up a set of protruding ridges on the top of the probe column, the distance from the stated probe column top to protruding lower end of the protruding ridges is smaller then the height of water bottle seal cap. The stated protruding is lined high and low. The stated protruding is lined on the same level.

The stated protruding is rectangle, or roundness, or ellipse, or semi-circle on the top and rectangle on the lower part. On the different diameter transition place of the stated probe column, set up edge rounding or level lined depression or high and low lined depression. The beneficial result of this practically used new type is: on the top of probe, on the circle set up a set of protruding, because it minimizes the contact area between probe and seal cap, the friction resistance is small, the probe is easy to enter the seal cap, and also can catch hold of it closely; on the side of probe, set up a set of long slot, which can make opening for water entering probe bigger, and the traveling distance for water entering the water cooler is short, water flow is good and with low noise.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is the main view for existing technology of this practically used new type patent;

FIG. 2 is the solid view for existing technology of this practically used new type patent;

FIG. 3 is the main view for one of the implementation examples of this practically used new type patent, in accordance with one embodiment of the present invention;

FIG. 4 is solid figure for FIG. 3, in accordance with one embodiment of the present invention;

FIG. 5 is sketch figure for protruding lined high and low in this practically used new type patent, in accordance with one embodiment of the present invention;

From FIG. 6 to FIG. 8, is the sketch figure for different shaped protrudings, in accordance with one embodiment of the present invention;

From FIG. 9 to FIG. 10, is the sketch figure for different shaped probe top, in accordance with one embodiment of the present invention; and

FIGS. 11 and 12 are the sketch figure for different shaped edge rounding on different diameter transition place on the probe, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

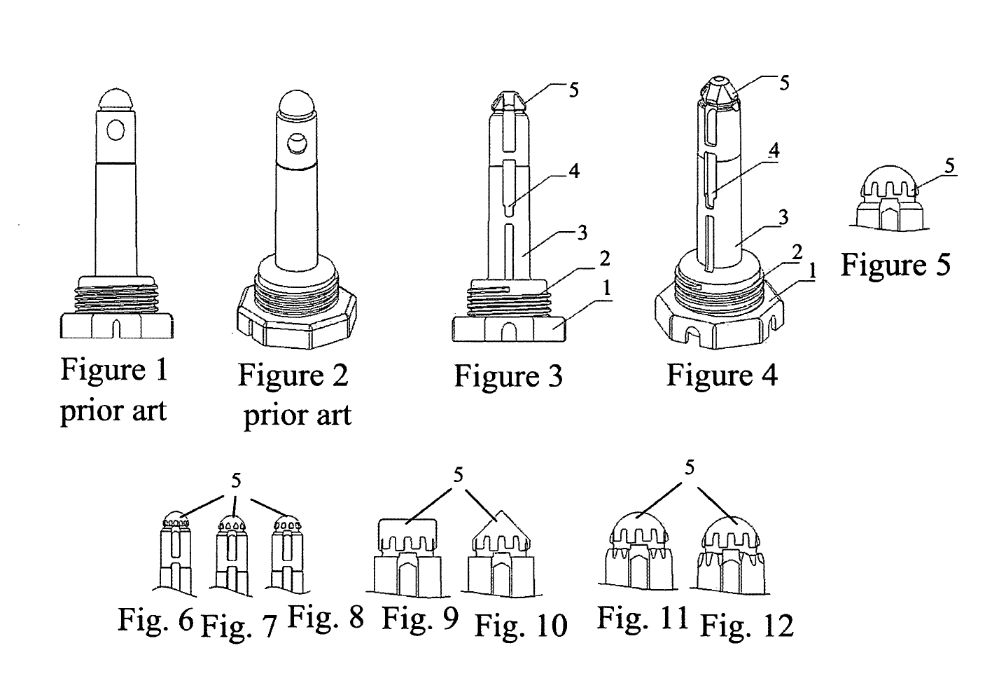

Now referring to FIGS. 1 and 2 they are both prior art.

Refer to FIGS. 3 and 4, as in one embodiment of the present invention, this implementation example has a hollow polygon bottom seat 1, and columniform threaded seat 2 and probe column 3 installed on it, on the side of the stated probe column 3, opening up a set of long slots 4 which is through the inside (in this example, opening up three long slot on the same erect direction), this design can make the opening bigger for water entering probe, also the traveling distance for water entering cooler is short, water flow is good and low noise;

In FIGS. 3 and 4, as in one embodiment of the present invention, the top diameter of the probe column is a little smaller then probe column's diameter, and setting up a set of protruding on the top, the distance from the stated probe column top to protruding lower end is smaller then the height of water bottle seal cap. Probe column 3 top is roundness, whose diameter is a little smaller then probe column 3's diameter, on the transition's place setting up edge rounding; on the top circle of probe column 3, setting up a set of rectangle protruding 5 lined on the same level (in this example, there are four protruding, and spaced evenly), this protruding is better then the traditional ring slot, its character is, it minimizes the contact area between probe and seal cap, and minimizes the friction resistance, so the probe can easily enter seal cap, and catch the seal cap easily; the distance between the stated probe column 3 top to protruding 5 lower part is smaller then the height of water bottle seal cap.

Referring to FIG. 5, as in one embodiment of the present invention, the stated protruding 5 also can be lined by high and low, and on different level, when the probe enters the seal cap, the protruding on the high place can enter first, if pressure increase or seal cap distortion increase, then the protruding on the lower place also enter the inside of seal cap and catch it, it is double protection; referring to FIGS. 6, 7 and 8, as in one embodiment of the present invention, the protruding 5's shape can be rectangle, or triangle or roundness, or ellipse, or semi-circle on the top and rectangle on the lower part. Referring to FIGS. 9 and 10, as in one embodiment of the present invention, probe top can be designed as cylindrical form or conic, easy to insert or pull; referring to FIGS. 11 and 12, as in one embodiment of the present invention, on the different diameter transition place of the stated probe column 3, can be same level lined depression or high and low lined depression. About the quantity of protruding, we choose 10 as an option but many different numbers have worked sufficiently.

While the present invention has been related in terms of the foregoing embodiments, those skilled in the art will recognize that the invention is not limited to the embodiments depicted. The present invention can be practiced with modification and alteration within the spirit and scope of the appended claims. Thus, the description is to be regarded as illustrative instead of restrictive on the present invention.

What is claimed is:

1. A probe for a water cooler comprising: a hollow polygonal bottom seat and columniform thread seat and probe column installed on the bottom seat, the probe column having openings forming a set of long slots, which can go through an inside of a pipe on a side of the probe column, a probe column top diameter is a little smaller then a probe column diameter, and there are at least one set of protruding ridges on the top of the probe column the distance between a probe column top end and the at least one protruding ridge is smaller then the height of a water bottle seal cap.

2. The probe of claim 1 wherein the at least one set of protruding ridges has peaks and valleys.

3. The probe of claim 1 wherein the at least one set of protruding ridges are level with each other.

4. The probe of claim 1 wherein the at least one set of protruding ridges are shaped as a selected one of a rectangle, triangle, circle, ellipse, semi-circle on a top of the protruding ridge and rectangle on a low part of the protruding ridge.

5. The probe of claim 1 wherein the probe column top is a selected one shape of rounded, cylindrical, and conic.

6. The probe of claim 4 wherein the probe column top is a selected one shape of rounded, cylindrical, and conic.

7. The probe of claim 1 wherein the probe column has a different diameter's transition place where there is an edge rounding or depression set up by a selected one of a level and depression set up by the peaks and valleys.

8. The probe of claim 4 wherein the probe column has a different diameter's transition place where there is an edge rounding or depression set up by a selected one of a level and depression set up by the peaks and valleys.

9. The probe of claim 5 wherein the probe column has a different diameter's transition place where there is an edge rounding or depression set up by a selected one of a level and depression set up by the peaks and valleys.

10. The probe of claim 6 wherein the probe column has a different diameter's transition place where there is an edge rounding or depression set up by a selected one of a level and depression set up by the peaks and valleys.
